(19) United States
(12) Patent Application Publication
(10) Pub. No.: US 2022/0106472 A1
(43) Pub. Date: Apr. 7, 2022

(54) EVA COMPOSITIONS FOR FOOTWEAR

(71) Applicant: Braskem S.A., Camaçari (BR)

(72) Inventors: Giancarlos Delevati, São Paulo (BR); Juliani Cappra Da Silva, São Paulo City (BR)

(73) Assignee: Braskem S.A., Camaçari (BR)

(21) Appl. No.: 17/496,123

(22) Filed: Oct. 7, 2021

Related U.S. Application Data
(60) Provisional application No. 63/088,887, filed on Oct. 7, 2020.

(51) Int. Cl. C08L 23/08; A43B 13/04; B29C 48/40; C08J 9/10

(52) U.S. Cl. CPC C08L 23/0853; A43B 13/04; B29K 2023/083; C08J 9/104; C08J 9/103; B29C 48/40

(57) ABSTRACT

A polymer composition may include one or more ethylene-vinyl acetate (EVA) copolymers in an amount ranging from 65 to 95 wt %; and an elastomer in an amount ranging from 5 to 35 wt %. Articles prepared from such polymer composition may include shoe soles, midsoles, outsoles, unisoles, insoles, monobloc sandals, flip flops, full EVA footwear, or sportive articles.

### BACKGROUND

Commercial rubber compositions may be formulated with a variety of primary and secondary polymers and various additives to tune performance based on the final application. For example, rubber compositions that are normally used in the footwear market require a large number of raw materials in order to achieve the attributes necessary for the application, leading to the production of complex and specialized mixtures.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a polymer composition that includes one or more ethylene-vinyl acetate (EVA) copolymers in an amount ranging from 65 to 95 wt %; and an elastomer in an amount ranging from 5 to 35 wt %.

In another aspect, embodiments disclosed herein relate to an article prepared from a polymer composition that includes one or more ethylene-vinyl acetate (EVA) copolymers in an amount ranging from 65 to 95 wt %; and an elastomer in an amount ranging from 5 to 35 wt %.

In yet another aspect, embodiments disclosed herein relate to a method that includes blending a polymer composition from a mixture comprising: one or more ethylene-vinyl acetate (EVA) copolymers, and an elastomer to form the polymer composition that includes one or more ethylene-vinyl acetate (EVA) copolymers in an amount ranging from 65 to 95 wt %; and an elastomer in an amount ranging from 5 to 35 wt %.

Other aspects and advantages of the claimed subject matter will be apparent from the following description and the appended claims.

### DETAILED DESCRIPTION

In one aspect, embodiments disclosed herein relate to EVA-based polymeric compositions containing EVA and at least one elastomeric polymer suited for a number of diverse applications. Polymer compositions in accordance with the present disclosure may be used to prepare expanded and non-expanded articles in applications including shoe sole components, including insoles, midsoles, and unisoles. EVA is a copolymer of the polyolefin family of elastomers formed by the sequence of random units derived from the polymerization of ethylene and vinyl acetate at high temperature and pressure. EVA copolymers provide materials that can be processed like other thermoplastics, but may offer a rubbery character having softness and elasticity. Advantageously, for articles needing a low compression set and shrinkage, and high rebound, which are generally not achievable using EVA, the present polymeric compositions have an improved softness (i.e., a decreased) hardness as compared to a conventional EVA, which will result in the compression set, shrinkage, and rebound properties desired for high performance articles.

Polymer compositions in accordance with the present disclosure may include the reaction products obtained from a mixture of: one or more EVA copolymers; an elastomeric polymer; and optionally one or more of blowing agent, curing agent, or blowing accelerator. Each of the components are discussed in turn as follows.

EVA Copolymer

Polymeric compositions in accordance with one or more embodiments may incorporate one or more ethylene-vinyl acetate (EVA) copolymers prepared by the copolymerization of ethylene and vinyl acetate. In some embodiments, the EVA copolymer can be derived from fossil sources (also referred to as petroleum-based EVA) or renewable sources (also referred to as biobased EVA). Biobased EVA is an EVA wherein at least one of ethylene and/or vinyl acetate monomers are derived from renewable sources, such as ethylene derived from biobased ethanol.

The use of products derived from natural sources, as opposed to those obtained from fossil sources, has increasingly been widely preferred as an effective means of reducing the increase in atmospheric carbon dioxide concentration, therefore effectively limiting the expansion of the greenhouse effect. Products thus obtained from natural raw materials have a difference, relative to fossil sourced products, in their renewable carbon contents. This renewable carbon content can be certified by the methodology described in the technical ASTM D 6866-18 Norm, “Standard Test Methods for Determining the Biobased Content of Solid, Liquid, and Gaseous Samples Using Radiocarbon Analysis”. Products obtained from renewable natural raw materials have the additional property of being able to be incinerated at the end of their life cycle and only producing CO₂ of a non-fossil origin.

Polymer compositions in accordance with the present disclosure may include EVA copolymers incorporating various ratios of ethylene and vinyl acetate, in addition to including one or more optional additional comonomers. EVA copolymers in accordance with the present disclosure may include a percent by weight (wt %) of vinyl acetate as determined according to ASTM D5594-98 that ranges from a lower limit selected from one of 8 wt %, 12 wt %, and 18 wt % to an upper limit selected from 28 wt %, 33 wt %, 40 wt %, 43 wt %, and 45 wt %, where any lower limit may be paired with any upper limit.

Specifically, in one or more embodiments, the EVA copolymer exhibits a bio-based carbon content, as determined by ASTM D6866-18 Method B, of at least 50%. Further, other embodiments may include at least 40%, 50%, 60%, 80%, or 100% bio-based carbon. As mentioned above, the total bio-based or renewable carbon in the EVA polymer may be contributed from a bio-based ethylene and/or a bio-based vinyl acetate. Each of these are described in turn.

For example, in one or more embodiments, the renewable source of carbon is one or more plant materials selected from the group consisting of sugar cane and sugar beet, maple, date palm, sugar palm, sorghum, American agave, corn, wheat, barley, sorghum, rice, potato, cassava, sweet potato, algae, fruit, materials comprising cellulose, wine, materials comprising hemicelluloses, materials comprising lignin, wood, straw, sugarcane bagasse, sugarcane leaves, corn stover, wood residues, paper, and combinations thereof.

In one or more embodiments, the bio-based ethylene may be obtained by fermenting a renewable source of carbon to produce ethanol, which may be subsequently dehydrated to produce ethylene. Further, it is also understood that the fermenting produces, in addition to the ethanol, byproducts of higher alcohols. If the higher alcohol byproducts are present during the dehydration, then higher alkene impurities may be formed alongside the ethanol. Thus, in one or more embodiments, the ethanol may be purified prior to dehydration to remove the higher alcohol byproducts while in other embodiments, the ethylene may be purified to remove the higher alkene impurities after dehydration.

Thus, biologically sourced ethanol, known as bio-ethanol, is obtained by the fermentation of sugars derived from cultures such as that of sugar cane and beets, or from hydrolyzed starch, which is, in turn, associated with other cultures such as corn. It is also envisioned that the bio-based ethylene may be obtained from hydrolysis-based products of cellulose and hemi-cellulose, which can be found in many agricultural by-products, such as straw and sugar cane husks. This fermentation is carried out in the presence of varied microorganisms, the most important of such being the yeast Saccharomyces cerevisiae. The ethanol resulting therefrom may be converted into ethylene by means of a catalytic reaction at temperatures usually above 300° C. A large variety of catalysts can be used for this purpose, such as high specific surface area gamma-alumina. Other examples include the teachings described in U.S. Pat. Nos. 9,181,143 and 4,396,789, which are herein incorporated by reference in their entirety.

Bio-based vinyl acetate, on the other hand, may also be used in one of more embodiments of the EVA copolymer of the present disclosure. Bio-based vinyl acetate may be produced by producing acetic acid by oxidation of ethanol (which may be formed as described above) followed by reaction of ethylene and acetic acid to acyloxylate the ethylene and arrive at vinyl acetate. Further, it is understood that the ethylene reacted with the acetic acid may also be formed from a renewable source as described above.

In one or more embodiments, a renewable starting material, including those described above, may be fermented and optionally purified, in order to produce at least one alcohol (either ethanol or a mixture of alcohols including ethanol). The alcohol may be separated into two parts, where the first part is introduced into a first reactor and the second part may be introduced into a second reactor. In the first reactor, the alcohol may be dehydrated in order to produce an alkene (ethylene or a mixture of alkenes including ethylene, depending on whether a purification followed the fermentation) followed by optional purification to obtain ethylene. One of ordinary skill in the art may appreciate that if the purification occurs prior to dehydration, then it need not occur after dehydration, and vice versa. In the second reactor, the alcohol may be oxidized in order to obtain acetic acid, which may optionally be purified. In a third reactor, the ethylene produced in the first reactor and the acetic acid produced in the second reactor may be combined and reacted to acyloxylate the ethylene and form vinyl acetate, which may be subsequently isolated and optionally purified. Additional details about oxidation of ethanol to form acetic acid may be found in U.S. Pat. No. 5,840,971 and Selective catalytic oxidation of ethanol to acetic acid on dispersed Mo—V-Nb mixed oxides. Li X, Iglesia E. Chemistry. 2007; 13(33):9324-30.

However, the present disclosure is not so limited in terms of the route of forming acetic acid. Rather, it is also envisioned that acetic acid may be obtained from a fatty acid, as described in “The Production of Vinyl Acetate Monomer as a Co-Product from the Non-Catalytic Cracking of Soybean Oil”, Benjamin Jones, Michael Linnen, Brian Tande and Wayne Seames, Processes, 2015, 3, 61-9-633. Further, the production of acetic acid from fermentation performed by acetogenic bacteria, as described in “Acetic acid bacteria: A group of bacteria with versatile biotechnological applications”. Saichana N, Matsushita K, Adachi 0, Frebort I, Frebortova J. Biotechnol Adv. 2015 Nov. 1; 33(6 Pt 2):1260-71 and Biotechnological applications of acetic acid bacteria. Raspor P, Goranovic D. Crit Rev Biotechnol. 2008; 28(2):101-24. Further, it is also understood that the production of ethylene used to produce vinyl acetate can also be used to form the ethylene that is subsequently reacted with the vinyl acetate to form the EVA copolymer of the present disclosure. Thus, for example, the amount of ethanol that is fed to the first and second reactors, respectively, may be vary depending on the relative amounts of ethylene and vinyl acetate being polymerized.

EVA copolymer in accordance with the present disclosure may have a melt flow index (MFI) at 190° C. and 2.16 kg as determined according to ASTM D1238 in a range having a lower limit selected from any of 1 g/10 min, 2 g/10 min, 3 g/10 min, and 4 g/10 min, to an upper limit selected from any of 10 g/10 min, 20 g/10 min, 30 g/10 min, 55 g/10 min, 100 g/10 min, and 150 g/10 min, where any lower limit may be paired with any upper limit.

EVA copolymer in accordance with the present disclosure may have a density determined according to ASTM D792 in a range having a lower limit selected from any of 0.80 g/cm³, 0.85 g/cm³, and 0.90 g/cm³, to an upper limit selected from any of 0.93 g/cm³, 0.94 g/cm³, and 0.98 g/cm³, where any lower limit may be paired with any upper limit.

Polymeric compositions in accordance with the present disclosure may contain the one or more EVA copolymer at a total percent by weight (wt %) of the composition that ranges from a lower limit of 65, 70, or 80 wt % to an upper limit of 80, 90, or 95 wt %, where any lower limit may be paired with any upper limit.

Elastomer

Polymeric compositions in accordance may incorporate an elastomer to lower the hardness, improve rebound, improve compression sets, and/or improve shrinkage, for example, of the EVA copolymer, depending on the end application. Elastomers in accordance with the present disclosure may include one or more of natural rubber, poly-isoprene (IR), isobutylene-isoprene rubber (IIR), styrene and butadiene rubber (SBR), polybutadiene rubber (BR), acrylonitrile-butadiene rubber (NBR), hydrogenated nitrile rubber (HNBR); polyolefin elastomers (POE), ethylene-propylene rubbers including ethylene-propylene rubber (EPM) and ethylene-propylene-diene rubber (EPDM), olefin block copolymers (OBC), and the like, acrylic rubbers such as polyacrylate rubber (ACM), halogen rubbers such as halogenated butyl rubbers including brominated butyl rubber and chlorinated butyl rubber, brominated isotubylene, polychloroprene (CR), and the like; silicone rubbers such as methylvinyl silicone rubber, dimethyl silicone rubber, and the like, sulfur-containing rubbers such as polysulfidic rubber; fluorinated rubbers; thermoplastic rubbers such as elastomers based on styrene, butadiene, isoprene, ethylene and propylene, styrene-isoprene-styrene (SIS), styrene-ethylene-butylene-styrene (SEBS), styrene-butylene-styrene (SBS), styrene-ethylene-propylene-styrene (SEPS) and the like, ethylene-vinyl acetate rubbers (having a high vinyl acetate content such as greater than 60% or 75-85%), epichlorohydrin rubber (ECO) ester-based elastomers, elastomeric polyurethane, elastomeric polyamide, and the like.

Elastomers in accordance with the present disclosure may have a hardness determined in accordance with ASTM D2240 in a range having a lower limit selected from any of 10 Shore A, 15 Shore A, and 20 Shore A, to an upper limit selected from any of 45 Shore A, 50 Shore A, 60 Shore A, 70 Shore A, and 80 Shore A, where any lower limit may be paired with any upper limit.

Polymeric compositions in accordance with the present disclosure may contain an elastomer at a percent by weight (wt %) of the composition that ranges from a lower limit of 5, 8, or 10 wt %, to an upper limit of 20, 30, or 35 wt %, where any lower limit may be paired with any upper limit.

Peroxide Agent

Polymeric compositions in accordance with the present disclosure may include one or more peroxide agents capable of generating free radicals during the polymer processing to promote curing. Peroxide agents may include benzoyl peroxide, dicumyl peroxide, di-tert-butyl peroxide, tert-butyl cumyl peroxide, tert-butyl 3,5,5-trimethylhexanoate peroxide, tert-butyl peroxybenzoate, 2-ethylhexyl carbonate tert-butyl peroxide, 2,5-dimethyl-2,5-di (tert-butylperoxide) hexane, 1,1-di(tert-butylperoxide)-3,3,5-trimethylcyclohexane,2,5-dimethyl-2,5-di(tertbutylperoxide), hexyne-3,3,3,5,7,7-pentamethyl-1,2,4-trioxepane, butyl 4,4-di (tert-butylperoxide) valerate, di (2,4-dichlorobenzoyl) peroxide, di(4-methylbenzoyl) peroxide, peroxide di(tert-butylperoxyisopropyl) benzene, 2,5-di(cumylperoxy)-2,5-dimethyl hexane, 2,5-di(cumylperoxy)-2,5-dimethyl hexyne-3,4-methyl-4-(t-butylperoxy)-2-pentanol, 4-methyl-4-(t-amylperoxy)-2-pentanol,4-methyl-4-(cumylperoxy)-2-pentanol, 4-methyl-4-(t-butylperoxy)-2-pentanone, 4-methyl-4-(t-amylperoxy)-2-pentanone, 4-methyl-4-(cumylperoxy)-2-pentanone, 2,5-dimethyl-2,5-di(t-butylperoxy)hexane, 2,5-dimethyl-2,5-di(t-amylperoxy)hexane, 2,5-dimethyl-2,5-di(t-butylperoxy)hexyne-3, 2,5-dimethyl-2,5-di(t-amylperoxy)hexyne-3, 2,5-dimethyl-2-t-butylperoxy-5-hydroperoxyhexane, 2,5-dimethyl-2-cumylperoxy-5-hydroperoxy hexane, 2,5-dimethyl-2-t-amylperoxy-5-hydroperoxyhexane, m/p-alpha, alpha-di[(t-butylperoxy)isopropyl]benzene, 1,3,5-tris(t-butylperoxyisopropyl)benzene, 1,3,5-tris(t-amylperoxyisopropyl)benzene, 1,3,5-tris(cumylperoxyisopropyl)benzene, di[1,3-dimethyl-3-(t-butylperoxy)butyl]carbonate, di[1,3-dimethyl-3-(t-amylperoxy)butyl]carbonate, di[1,3-dimethyl-3-(cumylperoxy)butyl]carbonate, di-t-amyl peroxide, t-amyl cumyl peroxide, t-butyl-isopropenylcumyl peroxide, 2,4,6-tri(butylperoxy)-s-triazine, 1,3,5-tri[1-(t-butylperoxy)-1-methylethyl]benzene, 1,3,5-tri-[(t-butylperoxy)-isopropyl]benzene, 1,3-dimethyl-3-(t-butylperoxy)butanol, 1,3-dimethyl-3-(t-amylperoxy)butanol, di(2-phenoxyethyl)peroxydicarbonate, di(4-t-butylcyclohexyl)peroxydicarbonate, dimyristyl peroxydicarbonate, dibenzyl peroxydicarbonate, di(isobornyl)peroxydicarbonate, 3-cumylperoxy-1,3-dimethylbutyl methacrylate, 3-t-butylperoxy-1,3-dimethylbutyl methacrylate, 3-t-amylperoxy-1,3-dimethylbutyl methacrylate, tri(1,3-dimethyl-3-t-butylperoxy butyloxy)vinyl silane, 1,3-dimethyl-3-(t-butylperoxy)butyl N-[1-{3-(1-methylethenyl)-phenyl)1-methylethyl]carbamate, 1,3-dimethyl-3-(t-amylperoxy)butyl N-[1-{3(1-methylethenyl)-phenyl)-1-methylethyl]carbamate, 1,3-dimethyl-3-(cumylperoxy))butyl N-[1-{3-(1-methylethenyl)-phenyl)-1-methylethyl]carbamate, 1,1-di(t-butylperoxy)-3,3,5-trimethylcyclohexane, 1,1-di(t-butylperoxy)cyclohexane, n-butyl 4,4-di(t-amylperoxy)valerate, ethyl 3,3-di(t-butylperoxy)butyrate, 2,2-di(t-amylperoxy)propane, 3,6,6,9,9-pentamethyl-3-ethoxycabonylmethyl-1,2,4,5-tetraoxacyclononane, n-buty 1-4,4-bis(t-butylperoxy)valerate, ethyl-3,3-di(t-amylperoxy)butyrate, benzoyl peroxide, OO-t-butyl-O-hydrogen-monoperoxy-succinate, OO-t-amyl-O-hydrogen-monoperoxy-succinate, 3,6,9, triethyl-3,6,9-trimethyl-1,4,7-triperoxynonane (or methyl ethyl ketone peroxide cyclic trimer), methyl ethyl ketone peroxide cyclic dimer, 3,3,6,6,9,9-hexamethyl-1,2,4,5-tetraoxacyclononane, 2,5-dimethyl-2,5-di(benzoylperoxy)hexane, t-butyl perbenzoate, t-butylperoxy acetate, t-butylperoxy-2-ethyl hexanoate, t-amyl perbenzoate, t-amyl peroxy acetate, t-butyl peroxy isobutyrate, 3-hydroxy-1,1-dimethyl t-butyl peroxy-2-ethyl hexanoate, OO-t-amyl-O-hydrogen-monoperoxy succinate, OO-t-butyl-O-hydrogen-monoperoxy succinate, di-t-butyl diperoxyphthalate, t-butylperoxy (3,3,5-trimethylhexanoate), 1,4-bis(t-butylperoxycarbo)cyclohexane, t-butylperoxy-3,5,5-trimethylhexanoate, t-butyl-peroxy-(cis-3-carboxy)propionate, allyl 3-methyl-3-t-butylperoxy butyrate, OO-t-butyl-O-isopropylmonoperoxy carbonate, OO-t-butyl-O-(2-ethyl hexyl)monoperoxy carbonate, 1,1,1-tris[2-(t-butylperoxy-carbonyloxy)ethoxymethyl]propane, 1,1,1-tris[2-(t-amylperoxy-carbonyloxy)ethoxymethyl]propane, 1,1,1-tris[2-(cumylperoxy-cabonyloxy)ethoxymethyl]propane, OO-t-amyl-O-isopropylmonoperoxy carbonate, di(4-methylbenzoyl)peroxide, di(3-methylbenzoyl)peroxide, di(2-methylbenzoyl)peroxide, didecanoyl peroxide, dilauroyl peroxide, 2,4-dibromo-benzoyl peroxide, succinic acid peroxide, dibenzoyl peroxide, di(2,4-dichloro-benzoyl)peroxide and combinations thereof.

In one or more embodiments, polymeric compositions in accordance with the present disclosure may contain one or more peroxide agents at a percent by weight (wt %) of the polymer composition of that ranges from a lower limit selected from one of 0.4 wt %, 0.65 wt %, 0.85 wt %, 1.27 wt %, and 1.7 wt %, to an upper limit selected from one of 2 wt %, 2.3 wt % 2.5 wt %, 2.9 wt %, 3.5 wt %, and 4.2 wt %, where any lower limit can be used with any upper limit.

Blowing Agent

Polymeric compositions in accordance with the present disclosure may include one or more blowing agents to produce expanded polymeric compositions and foams. Blowing agents may include solid, liquid, or gaseous blowing agents. In embodiments utilizing solid blowing agents, blowing agents may be combined with a polymer composition as a powder or granulate.

Blowing agents in accordance with the present disclosure include chemical blowing agents that decompose at polymer processing temperatures, releasing the blowing gases such as N₂, CO, CO₂, and the like. Examples of chemical blowing agents may include organic blowing agents, including hydrazines such as toluenesulfonyl hydrazine, hydrazides such as oxydibenzenesulfonyl hydrazide, diphenyl oxide-4,4′-disulfonic acid hydrazide, and the like, nitrates, azo compounds such as azodicarbonamide, cyanovaleric acid, azobis(isobutyronitrile), and N-nitroso compounds and other nitrogen-based materials, and other compounds known in the art.

Inorganic chemical blowing agents may include carbonates such as sodium hydrogen carbonate (sodium bicarbonate), sodium carbonate, potassium bicarbonate, potassium carbonate, ammonium carbonate, and the like, which may be used alone or combined with weak organic acids such as citric acid, lactic acid, or acetic acid.

In one or more embodiments, polymeric compositions in accordance with the present disclosure may contain one or more blowing agents at a percent by weight (wt %) of the polymer composition that ranges from a lower limit selected from one of 0.9 wt %, 1.3 wt %, 1.7 wt %, 2.1 wt %, and 2.5 wt %, to an upper limit selected from one of 2.9 wt %, 3.3 wt %, 3.7 wt %, 4.1 wt %, 4.5 wt %, and 5 wt %, where any lower limit can be used with any upper limit.

Blowing Accelerators

Polymeric compositions in accordance with the present disclosure may include one or more blowing accelerators (also known as kickers) that enhance or initiate the action of a blowing agent by lower the associated activation temperature. For example, blowing accelerators may be used if the selected blowing agent reacts or decomposes at temperatures higher than 170° C., such as 220° C. or more, where the surrounding polymer would be degraded if heated to the activation temperature. Blowing accelerators may include any suitable blowing accelerator capable of activating the selected blowing agent. In one or more embodiments, suitable blowing accelerators may include cadmium salts, cadmium-zinc salts, lead salts, lead-zinc salts, barium salts, barium-zinc (Ba—Zn) salts, zinc oxide, titanium dioxide, triethanolamine, diphenylamine, sulfonated aromatic acids and their salts, and the like.

In one or more embodiments, polymeric compositions in accordance with the present disclosure may contain one or more blowing accelerators at a percent by weight (wt %) of the polymer composition that ranges from a lower limit selected from one of 0.08 wt %, 0.2 wt %, 0.4 wt %, 0.8 wt %, 1.65 wt %, and 2 wt %, to an upper limit selected from one of 2 wt % 2.5 wt %, 2.8 wt %, 3.25 wt %, 3.6 wt %, and 4 wt %, where any lower limit can be used with any upper limit.

Additives

Polymeric compositions in accordance with the present disclosure may include additives that modify various physical and chemical properties when added to the polymeric composition during blending that include one or more polymer additives such as processing aids, lubricants, antistatic agents, clarifying agents, nucleating agents, beta-nucleating agents, slipping agents, antioxidants, compatibilizers, antacids, light stabilizers such as HALS, IR absorbers, whitening agents, inorganic fillers, organic and/or inorganic dyes, anti-blocking agents, processing aids, flame-retardants, biocides, adhesion-promoting agents, metal oxides, mineral fillers, glidants, oils, anti-oxidants, antiozonants, accelerators, and vulcanizing agents. In one or more particular embodiments, the polymeric compositions of the present disclosure may achieve the desired physical properties while being substantially free of plasticizers (i.e., at less than 0.5 wt %). Plasticizers may be known to seep to the surface in an article when the article is exposed to elevated temperatures and cause the article to become more rigid over time. Advantageously, the polymeric compositions described herein may achieve the desired properties without the use of plasticizer, allowing the compositions (and articles formed therefrom) to maintain performance over time and exposure to elevated temperatures.

Further, it is also envisioned that when using biobased EVA in the polymeric composition, it may be desirable to also include a biobased polyolefin such as a biobased polyethyelene in order to increase the biobased content of the polymer composition. Such biobased polyethylene may include, in a particular embodiment, a low density polyethylene.

Polymeric compositions in accordance with the present disclosure may be loaded with fillers that may include carbon black, silica powder, calcium carbonate, talc, titanium dioxide, clay, polyhedral oligomeric silsesquioxane (POSS), metal oxide particles and nanoparticles, inorganic salt particles and nanoparticles, recycled EVA, and mixtures thereof.

As defined herein, recycled EVA may be derived from regrind materials that have undergone at least one processing method such as molding or extrusion and the subsequent sprue, runners, flash, rejected parts, and the like, are ground or chopped.

In one or more embodiments, polymeric compositions in accordance with the present disclosure one or more fillers at a percent by weight (wt %) of the polymer composition that ranges from a lower limit selected from one of 4 wt %, 8 wt %, 12 wt %, 15 wt %, 18 wt %, 22%, and 27 wt %, to an upper limit selected from one of 35 wt %, 42 wt %, 47 wt %, 52 wt %, 56 wt %, and 59 wt %, where any lower limit can be used with any upper limit.

Preparation

Polymeric compositions in accordance with the present disclosure may be prepared in any conventional mixture device. In one or more embodiments, polymeric compositions may be prepared by mixture in conventional kneaders, banbury mixers, mixing rollers, single, twin, or multi screw extruders, and the like, in conventional EVA processing conditions and subsequently cured and expanded in conventional expansion processes, such as injection molding or compression molding.

Properties

Polymeric compositions in accordance with the present disclosure may have good performance as a replacement for rubber materials, providing an EVA-based composition with acceptable performance at high and low temperatures.

In one or more embodiments, the polymeric composition exhibits a bio-based carbon content, as determined by ASTM D6866-18 Method B, of at least 30%. Further, other embodiments may include at least 40%, 50%, 60%, 80%, or 90% bio-based carbon.

Polymeric compositions in accordance with the present disclosure may have a density determined according to ASTM D792 in a range having a lower limit selected from any of 0.92 g/cm³, 0.95 g/cm³, and 0.93 g/cm³, to an upper limit selected from any of 0.93 g/cm³, 0.935 g/cm³, 0.94 g/cm³ and 0.95 g/cm³ where any lower limit may be paired with any upper limit.

Polymeric compositions in accordance with the present disclosure may have a melt flow index (MFI) at 190° C. and 2.16 kg as determined according to ASTM D1238 in a range having a lower limit selected from any of 3 g/10 min, 4.0 g/10 min, 5.0 g/10 min, and 6.0 g/10 min, to an upper limit selected from any of 7.0 g/10 min, 8.0 g/10 min, 9.0 g/10 min, and 10 g/10 min, where any lower limit may be paired with any upper limit.

Polymeric compositions in accordance with the present disclosure may have a hardness as determined by ASTM D2240 within a range having a lower limit selected from one of 55, 60, 65, and 70 Shore A, to an upper limit selected from one of 75, 80, 85, and 90 Shore A, where any lower limit may be paired with any upper limit.

Polymer compositions in accordance with the present disclosure may have a hardness as determined by ASTM D2240 within a range having a lower limit selected from one of 10, 15, 18, and 20 Shore D, to an upper limit selected from one of 25, 30, 35, and 40 Shore D, where any lower limit may be paired with any upper limit.

Polymeric compositions in accordance with the present disclosure may have an abrasion resistance as determined by ISO 4649:2017 with a testing load of ION within a range having a lower limit selected from one of 50 mm³, 100 mm³, 150 mm³, 200 mm³, 250 mm³, 300 mm³, and 350 mm³, to an upper limit selected from one of 250 mm³, 300 mm³, 450 mm³, 500 mm³, 550 mm³ and 600 mm³, where any lower limit may be paired with any upper limit.

In one or more embodiments, polymeric compositions may have a total vinyl acetate content in the polymeric composition ranging from a lower limit of any of greater than 10 wt %, 14 wt %, 18 wt %, 21 wt %, or 24 wt %, or an upper limit of any of 24 wt %, 27 wt %, or less than 30 wt %, where any lower limit can be used in combination with any upper limit.

Polymeric compositions in accordance with the present disclosure may have a rebound as determined by DIN 53512:2000 within a range having a lower limit selected from one of 20%, 30%, 35%, and 40% to an upper limit selected from one of 50%, 55% and 60%, where any lower limit may be paired with any upper limit.

Polymer compositions in accordance with the present disclosure may have a Vicat as determined by ASTM D1525 measured at 50° C./h at a load of 10 N that may range from a lower limit of any of 30° C., 35° C., 40° C., and 45° C. to an upper limit of any of 45° C., 50° C., 55° C., 60° C. and 70° C., where any lower limit may be paired with any upper limit.

Polymer compositions in accordance with the present disclosure may have a Static Coefficient of Friction as determined by ASTM D1894 Method C that may range from a lower limit of any of 0.3, 0.45, 0.5 and 0.55 to an upper limit of any of 0.6, 0.7, 0.8, 0.9, 0.99 and 1, where any lower limit may be paired with any upper limit.

Polymer compositions in accordance with the present disclosure may have a Dynamic Coefficient of Friction as determined by ASTM D1894 Method C that may range from a lower limit of any of 0.3, 0.45, 0.5 and 0.55 to an upper limit of any of 0.6, 0.7, 0.8, 0.9, 0.99 and 1, where any lower limit may be paired with any upper limit.

In one or more embodiments, polymer compositions having such hardness may produce expanded articles that exhibit low compression set and shrinkage, and high rebound that may be particularly desirable for use in high performance athletic shoes. In one or more embodiments, articles prepared from polymer compositions in accordance with the present disclosure may take the form of expanded or non-expanded polymer structures.

Expanded articles prepared by the polymer compositions in accordance with the present disclosure may have a hardness as determined by ASTM D2240 within a range having a lower limit selected from one of 10, 15, 20, 45, and 50 Shore A, to an upper limit selected from one of 27, 35, 50, and 60 Shore A, where any lower limit may be paired with any upper limit.

Expanded articles prepared by the polymer compositions in accordance with the present disclosure may have a hardness as determined by ABNT NBR 14455 within a range having a lower limit selected from one of 10, 15, 20, 45, and 50 Asker C, to an upper limit selected from one of 55, 65, 75, and 80 Asker C, where any lower limit may be paired with any upper limit.

Expanded articles prepared by the polymer compositions in accordance with the present disclosure may have a density as determined by ASTM D-792 within a range having a lower limit selected from one of 0.12 g/cm³, 0.2 g/cm³, 0.25 g/cm³, 0.5 g/cm³, and 0.15 g/cm³, to an upper limit selected from one of 0.4 g/cm³, 0.5 g/cm³, 0.6 g/cm³, 0.65 g/cm³, 0.80 g/cm³ and 1.0 g/cm³, where any lower limit may be paired with any upper limit.

Expanded articles prepared by the polymer compositions in accordance with the present disclosure may have a shrinkage at 70° C.*1 h using the PFI method (PFI “Testing and Research Institute for the Shoe Manufacturing Industry” in Pirmesens-Germany) within a range having a lower limit selected from one of 0.1%, 0.5%, 1%, and 1.5%, to an upper limit selected from one of 2%, 4%, 5%, 6%, and 8%, where any lower limit may be paired with any upper limit.

Expanded articles prepared by the polymer compositions in accordance with the present disclosure may have a permanent compression set (PCS) as determined by ASTM D395 method B within a range having a lower limit selected from one of 10%, 20%, and 30% to an upper limit selected from one of 35%, 40% 45%, and 50%, where any lower limit may be paired with any upper limit.

Expanded articles prepared by the polymer compositions in accordance with the present disclosure may have a rebound as determined by ASTM D3574 within a range having a lower limit selected from one of 50%, 60%, and 70% to an upper limit selected from one of 70%, 80% and 90%, where any lower limit may be paired with any upper limit.

Expanded articles prepared by the polymer compositions in accordance with the present disclosure may have an abrasion resistance as determined by ISO 4649:2017 with a testing load of 5N within a range having a lower limit selected from one of 50 mm³ 100 mm³, 150 mm³, 200 mm³, 450 mm³, 500 mm³, and 650 mm³, to an upper limit selected from one of 300 mm³, 600 mm³, 700 mm³, 800 mm³, where any lower limit may be paired with any upper limit.

Applications

Polymer compositions in accordance with the present disclosure may exhibit similar or improved properties when compared to standard rubbers or unmodified EVA copolymers. In one or more embodiments, polymeric compositions may be used in a number of molding processes including extrusion molding, injection molding, compression molding, thermoforming, foaming, pultrusion, 3D printing, and the like, to produce manufactured articles.

Polymeric compositions in accordance with the present disclosure may be formed into articles used for a diverse array of end-uses including shoe soles, midsoles, outsoles, unisoles, insoles, monobloc sandals and flip flops, full EVA footwear, sportive articles, and the like. In particular embodiments, the polymeric compositions may be formed into articles including insoles, midsoles, and unisoles for high performance athletic shoes.

### EXAMPLES

In the following examples, polymer compositions formulations where prepared and assayed to study various physical properties.

### Example 1—Preparation of Polymer Compositions

In the following example, polymer composition formulations were prepared in a twin screw extruder at a temperature of 100° C. to 140° C. and at 330 rpm. Polymer composition formulations are shown in Table 1.

TABLE 2
Polymer Composition Formulations

| | C1 | C2 | C3 |
|---|---|---|---|
| Material | PHR | PHR | PHR |
| EVA 28% VA (HM-728 from | 0 | 0 | 50 |
| Braskem) | | | |
| SEBS (LCY 7551) | 0 | 0 | 10 |
| Bio-based EVA (SVT2180 from | 50 | 50 | 0 |
| Braskem) | | | |
| LDPE (SPB608 from Braskem) | 0 | 15 | 0 |
| EVA 40% VA (ELVAX 40W) | 25 | 20 | 20 |
| Olefin Block Copolymer | 25 | 15 | 20 |
| (Infuse 9807) | | | |
| Total | 100 | 100 | 100 |

Samples were assayed for different properties, and the results are shown in Table 2.

TABLE 2
Properties of the polymer composition formulations

| Properties | Unit | Standard | C1 | | C2 | | C3 | |
|---|---|---|---|---|---|---|---|---|
| Melt Flow Index | g/10 min | ASTM | 6.69 | | 6.19 | | 4.48 | |
| | | D1238(190° C.@2.16 kg) | | | | | | |
| Hardness Shore A | Shore A | ASTM D2240 | 87 | | 79 | | 69 | |
| Hardness Shore D | Shore D | ASTM D2240 | 28 | | 22 | | 19 | |
| Density | g/cm³ | ASTM D792 | 0.930 | | 0.928 | | 0.935 | |
| Abrasion resistance | mm³ | ISO 4649: 2017 with | 140 | | 244 | | 533 | |
| | | a testing load of 10N | | | | | | |
| Rebound | % | DIN 53512: 2000 | 36% | | 38% | | 45% | |
| Vicat | ° C. | ASTM D1525 | 46.1° | C. | 40.9° | C. | 40.7° | C. |
| | | (50° C./h load of 10N) | | | | | | |
| Tensile Strength at | MPa | ASTM D638 - Test | 6.5 | | 5.2 | | 4.4 | |
| Break | | specimen type IV | | | | | | |
| Elongation at Break | % | ASTM D638 - Test | 306.1% | | 330.9% | | 475.5% | |
| | | specimen type IV | | | | | | |
| Tensile strength at 20% | MPa | ASTM D638 - Test | 3.8 | MPa | 2.5 | MPa | 2.4 | MPa |
| deformation | | specimen type IV | | | | | | |

| | | | | | |
|---|---|---|---|---|---|
| Young Modulus | MPa | ASTM D638 - Test | 39 | 21 | 11 |
| | | specimen type IV | | | |
| Total Vinyl acetate | wt % | ASTM D5594-98 | 16% | 18% | 23% |
| content | | | | | |
| Static Coefficient of | | ASTM D1894, | 0.98 | 0.54 | 0.47 |
| Friction | | Method C | | | |
| Dynamic Coefficient of | | ASTM D1894, | 0.86 | 0.47 | 0.36 |
| Friction | | Method C | | | |

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A polymer composition, comprising:
one or more ethylene-vinyl acetate (EVA) copolymers in an amount ranging from 65 to 95 wt %; and
an elastomer in an amount ranging from 5 to 35 wt %.

2. The polymer composition of claim 1, further comprising one or more selected from a group consisting of base polymer, peroxide agent, blowing agent, and blowing accelerator.

3. The polymer composition of claim 1, wherein the one or more EVA copolymers each comprise a vinyl acetate at a percent by weight of the EVA copolymer that ranges from 8 wt % to 45 wt %.

4. The polymer composition of claim 1, wherein the polymer composition has a total vinyl acetate content ranging from greater than 10 wt % to less than 30% of the polymer composition.

5. The polymer composition of claim 1, wherein the polymer composition exhibits a hardness as determined by ASTM D2240 in the range of 55 to 90 Shore A.

6. The polymer composition of claim 1, wherein the polymer composition has a biobased content, as determined by ASTM D6866-18 Method B, of at least 30%.

7. The polymer composition of claim 1, wherein the elastomer is selected from the group consisting of polyolefin elastomers, olefin block copolymers, SEBS, SEPS, SBS, and SIS.

8. The polymer composition of claim 1, wherein the composition is an expanded polymer composition.

9. The polymer composition of claim 1, wherein the polymer composition is an expanded polymer composition that exhibits a shrinkage according to the PFI method at less than 2%.

10. The polymer composition of claim 1, wherein the polymer composition is an expanded polymer composition that exhibits a permanent compression set as determined by ASTM D395 method B at less than 45%.

11. The polymer composition of claim 1, wherein the polymer composition is an expanded polymer composition that exhibits a rebound as determined by ASTM D3574 that is greater than 50%.

12. An article prepared from the composition of claim 1.

13. The article of claim 12, wherein the article is selected from a group consisting of shoe soles, midsoles, outsoles, unisoles, insoles, monobloc sandals, flip flops, full EVA footwear, and sportive articles.

14. A method, comprising:
blending a polymer composition from a mixture comprising: one or more ethylene-vinyl acetate (EVA) copolymers, and an elastomer to form the polymer composition of claim 1.

15. The method of claim 14, wherein blending the polymer composition comprises processing the mixture using a kneader, banbury mixer, mixing roller, or twin screw extruder.

16. The method of claim 14, wherein the method further comprises:
curing and expanding the polymer composition.
